(19) United States
(12) Patent Application Publication
(10) Pub. No.: US 2014/0176964 A1
(43) Pub. Date: Jun. 26, 2014

(54) OPTICAL TOUCH SYSTEM

(71) Applicant: Pixart Imaging Inc., Hsin-Chu (TW)

(72) Inventors: Tzung Min Su, Hsinchu City (TW); Yu Chia Lin, Hsinchu City (TW); Kuan Hsun Wang, Hsinchu City (TW); Chuan-Ching Lin, Hsinchu City (TW); Chih Hsin Lin, Hsinchu City (TW)

(73) Assignee: PIXART IMAGING INC., Hsin-Chu (TW)

(21) Appl. No.: 14/011,312

(22) Filed: Aug. 27, 2013

(30) Foreign Application Priority Data
Dec. 26, 2012 (TW) 101150007

(51) Int. Cl. G01B 11/00

(52) U.S. Cl. CPC G01B 11/002
USPC 356/614

(57) ABSTRACT

An optical touch system comprises a first light-emitting unit, a second light-emitting unit, a first image sensor having a first filter, and a second image sensor having a second filter. The first light-emitting unit generates first wavelength band light. The second light-emitting unit generates second wavelength band light. The first light-emitting unit generates first wavelength band light when the first image sensor is capturing an image. The first filter allows first wavelength band light to enter into the first image sensor and blocks second wavelength band light. The second light-emitting unit generates second wavelength band light when the second image sensor is capturing an image. The second filter allows second wavelength band light to enter into the second image sensor and block first wavelength band light.

### CROSS-REFERENCE TO RELATED APPLICATION

The present application is based on, and claims priority from, Taiwan Patent Application Serial Number 101150007, filed on Dec. 26, 2012, the disclosure of which is hereby incorporated by reference herein in its entirety.

### BACKGROUND

1. Technical Field

The present invention relates to an optical touch system.

2. Related Art

In an optical touch system, an image sensor is used to capture images of an object. The optical touch system then analyzes the positions of object images in pictures generated by the image sensor, and then determines the coordinates of the object by the positions of the object images.

U.S. Pat. No. 4,782,328 discloses a touch screen system, which comprises two image sensors and a processor coupled with the two image sensors. The two image sensors are used to capture images of an object on a touch screen. The processor is used to determine the sensing paths that respectively connect the object and the two image sensors and to calculate the coordinates of the object by the sensing paths.

A touch screen system may have a light source, which projects light toward an object on the touch screen so that the image sensors can capture bright images of the object.

A touch system may have a plurality of image sensors and a plurality of light sources used with the image sensors. The image sensors and the light sources are disposed along the sides of a touch area. When the image sensors simultaneously capture images, each image sensor is under the influence of the light from the light sources disposed on different sides of the touch area. In particular, when the object to be detected is small, its object images cannot be easily captured due to the influence of the light from the opposite side. In order to prevent such a situation from happening, the plurality of image sensors are arranged to alternately capture images. However, when there is a large number of image sensors and the object is moving, the object image captured by the first image sensor and the object image captured by the last image sensor will appear to be significantly different, which may result in incorrect calculations.

### SUMMARY

In view of the above issues, several embodied optical touch systems are provided.

An optical system according to one embodiment of the present invention comprises at least one first light-emitting unit, at least one second light-emitting unit, at least one first image sensor comprising a first filter, and at least one second image sensor comprising a second filter. The at least one first light-emitting unit is configured to generate first wavelength band light. The at least one second light-emitting unit is configured to generate second wavelength band light. The at least one first light-emitting unit is configured to generate the first wavelength band light when the at least one first image sensor is capturing images. The first filter is configured to allow the first wavelength band light to enter into the at least one first image sensor and to prevent the second wavelength band light from entering into the at least one first image sensor. The at least one second light-emitting unit is configured to generate the second wavelength band light when the at least one second image sensor is capturing images. The second filter is configured to allow the second wavelength band light to enter into the at least one second image sensor and to prevent the first wavelength band light from entering into the at least one second image sensor.

An optical system according to another embodiment of the present invention comprises at least one first image-sensing device comprising a light-emitting unit and an image sensor, and at least one second image-sensing device comprising a light-emitting unit and an image sensor. The image sensor of the at least one first image-sensing device comprises a first filter. The light-emitting unit of the at least one first image-sensing device is configured to generate first wavelength band light when the image sensor of the at least one first image-sensing device is capturing images. The image sensor of the at least one second image-sensing device comprises a second filter. The light-emitting unit of the at least one second image-sensing device is configured to generate second wavelength band light when the image sensor of the at least one second image-sensing device is capturing images. The first filter is configured to allow the first wavelength band light to pass through and to block the second wavelength band light. The second filter is configured to allow the second wavelength band light to pass through and to block the first wavelength band light.

An optical system according to another embodiment of the present invention comprises a first group of image-sensing devices disposed on a side of a touch area, a second group of image-sensing devices disposed on another side of the touch area opposite to the side, and a processor.

The first group of image-sensing devices comprises a first image-sensing device comprising a light-emitting unit and an image sensor comprising a filter, and a second image-sensing device comprising a light-emitting unit and an image sensor comprising a filter. The light-emitting unit of the first image-sensing device is configured to generate first wavelength band light when the image sensor of the first image-sensing device is capturing images. The light-emitting unit of the second image-sensing device is configured to generate second wavelength band light when the image of the second image-sensing device is capturing images, wherein the filter of the first image-sensing device is configured to allow the first wavelength band light to pass through and to block the second wavelength band light, and the filter of the second image-sensing device is configured to allow the second wavelength band light to pass through and to block the first wavelength band light.

The second group of image-sensing devices comprises a third image-sensing device comprising a light-emitting unit and an image sensor comprising a filter and a fourth image-sensing device comprising a light-emitting unit and an image sensor comprising a filter. The light-emitting unit of the third image-sensing device is configured to generate the first wavelength band light when the image sensor of the third image-sensing device is capturing images. The light-emitting unit of the fourth image-sensing device is configured to generate the second wavelength band light when the image sensor of the fourth image-sensing device is capturing images, wherein the filter of the third image-sensing device is configured to allow the first wavelength band light to pass through and to block the second wavelength band light, and the filter of the fourth image-sensing device is configured to allow the second wavelength band light to pass through and to block the first wavelength band light.

The processor is configured to sequentially control the first and second group of image-sensing devices to capture images.

An optical system according to another embodiment of the present invention comprises first and second image-sensing devices. Each of the first and second image-sensing devices comprises an image sensor and a light-emitting unit. Each image sensor comprises a filter. The light-emitting unit is configured to generate light when the image sensor is capturing images. The first image-sensing device is disposed near a center of a field-of-view of the second image-sensing device.

The optical systems of some embodiments use light of different wavelength bands to capture images so that at least a portion of image sensors can simultaneously capture images and the optical systems will not produce incorrect calculations.

To provide a better understanding of the above-described objectives, characteristics and advantages of the present invention, a detailed explanation is provided in the following embodiments with reference to the drawings.

### BRIEF DESCRIPTION OF THE DRAWINGS

The invention will be described according to the appended drawings in which:

FIG. 1 schematically shows an optical touch system according to one embodiment of the present invention;

FIG. 2 is a diagram of an optical touch system according to one embodiment of the present invention;

FIG. 3 schematically shows an optical touch system according to another embodiment of the present invention;

FIG. 4 is a diagram of the optical touch system;

FIG. 5 schematically shows an electronic system according to one embodiment of the present invention;

FIG. 6 schematically shows an optical touch system according to another embodiment of the present invention;

FIG. 7 is a diagram of the optical touch system;

FIG. 8 schematically shows an optical touch system according to another embodiment of the present invention; and

FIG. 9 schematically shows an optical touch system according to another embodiment of the present invention.

### DETAILED DESCRIPTION OF DISCLOSED EMBODIMENTS

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

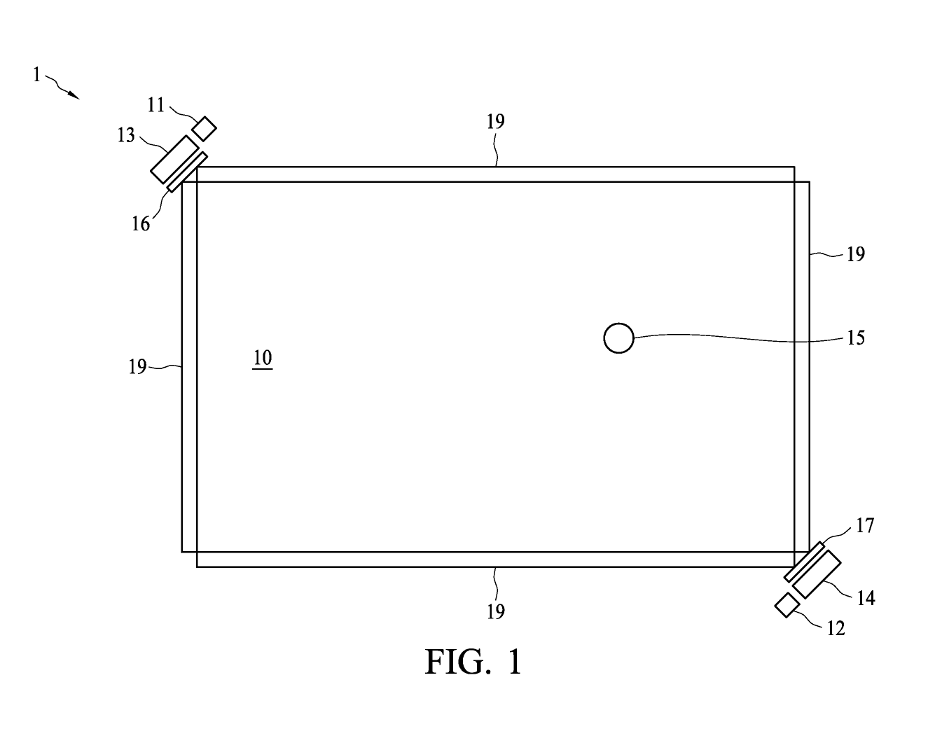

FIG. 1 schematically shows an optical touch system 1 according to one embodiment of the present invention. Referring to FIG. 1, the optical touch system 1 may comprise a first light-emitting unit 11, a second light-emitting unit 12, a first image sensor 13, and a second image sensor 14. The first image sensor 13 is configured to detect an object 15 on an area 10 such as a touch area. The first light-emitting unit 11 and the first image sensor 13 can be arranged in a group or used together. The first light-emitting unit 11 is configured to generate light that illuminates the object 15 when the first image sensor 13 is capturing the images of the object 15 so that pictures from the first image sensor 13 may be generated with a bright image of the object 15. The first light-emitting unit 11 is configured to generate first wavelength band light. The first image sensor 13 can be equipped with a first filter 16, which may be, for example, a band pass filter. The first filter 16 is configured to allow the first wavelength band light to enter into the first image sensor 13. The second light-emitting unit 12 and the second image sensor 14 may be arranged in a group or used together. The second light-emitting unit 12 is configured to generate light that illuminates the object 15 when the second image sensor 14 is capturing images of the object 15 so that the pictures from the second image sensor 14 can be generated with a bright image of the object 15. The second light-emitting unit 12 is configured to generate second wavelength band light. The second image sensor 14 may be equipped with a second filter 17, which may be, for example, a band pass filter. The second filter 17 is configured to allow second wavelength band light to enter into the second image sensor 14.

In one embodiment, the light from the first light-emitting unit 11 can shine on the second image sensor 14, and the second filter 17 can prevent the first wavelength band generated by the first light-emitting unit 11 from entering into the second image sensor 14. The light from the second light-emitting unit 12 can shine on the first image sensor 13, and the first filter 16 can prevent the second wavelength band light generated by the second light-emitting unit 12 from entering into the first image sensor 13. Thus, the first image sensor 13 and the second image sensor 14 can simultaneously capture images of the object 15 without being influenced by the light from the light-emitting unit that is not arranged in the same group.

In one embodiment, the first filter 16 allows the first wavelength band light to pass through while blocking light of a wavelength band other than the first wavelength band. The second filter 17 allows the second wavelength band light to pass through while blocking light of a wavelength band other than the second wavelength band.

In one embodiment, the first wavelength band light can have a central wavelength of 850 nanometers and the second wavelength band light can have a central wavelength of 940 nanometers.

In one embodiment, the area 10 can have two opposite corners. The first light-emitting unit 11 and the first image sensor 13 can be disposed on one corner, and the second light-emitting unit 12 and the second image sensor 14 can be disposed on another corner. Thus, the first light-emitting unit 11 and the second image sensor 14 face toward each other, and the second light-emitting unit 12 and the first image sensor 13 face toward each other.

In one embodiment, the area 10 can comprise two opposite sides, wherein the first light-emitting unit 11 and the first image sensor 13 are disposed on one side, and the second light-emitting unit 12 and the second image sensor 14 are disposed on another side.

In one embodiment, the area 10 can comprise two adjacent sides, wherein the first light-emitting unit 11 and the first image sensor 13 are disposed on one side, and the second light-emitting unit 12 and the second image sensor 14 are disposed on another side.

In one embodiment, the first light-emitting unit 11 or the second light-emitting unit 12 comprises a light-emitting diode. However, the present invention is not limited to such embodiment.

In one embodiment, the first light-emitting unit 11 or the second light-emitting unit 12 comprises a broadband light source and an optical filter.

In one embodiment, the first light-emitting unit 11 and the first image sensor 13 are integrated as an image-sensing device, and the second light-emitting unit 12 and the second image sensor 14 are integrated as an image-sensing device. In one embodiment, the first light-emitting unit 11 and the first image sensor 13 are two individual devices, and the second light-emitting unit 12 and the second image sensor 14 are two individual devices.

Referring to FIG. 1, in one embodiment, the optical touch system 1 may comprise a retro-reflector 19, which may be disposed adjacent to the area 10 and configured to reflect first or second wavelength band light.

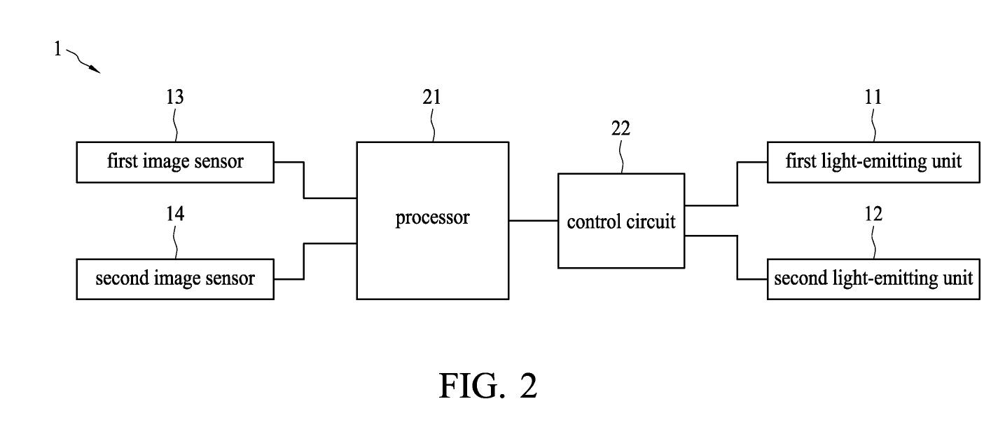

FIG. 2 is a diagram of an optical touch system 1 according to one embodiment of the present invention. Referring to FIG. 2, the optical touch system 1 may comprise a processor 21, which can be configured to control the first image sensor 13 and the second image sensor 14 to capture images. In one embodiment, the processor 21 controls the first image sensor 13 and the second image sensor 14 to capture images synchronously. In one embodiment, the processor 21 controls the first image sensor 13 and the second image sensor 14 to capture images asynchronously.

Referring to FIG. 2, the optical touch system 1 may further comprise a control circuit 22, which may be coupled with the first light-emitting unit 11 and the second light-emitting unit 12. The control circuit 22 can be used to turn the first light-emitting unit 11 on or off, and turn the second light-emitting unit 12 on or off. The control circuit 22 may be coupled with the processor 21 such that when the processor 21 controls the first image sensor 13 to capture images, the processor 21 can simultaneously control the control circuit 22 to turn on the first light-emitting unit 11 to allow the first image sensor 13 to capture bright object images. When the processor 21 controls the second image sensor 14 to capture images, the processor 21 can simultaneously control the control circuit 22 to turn on the second light-emitting unit 12 to allow the second image sensor 14 to capture bright object images.

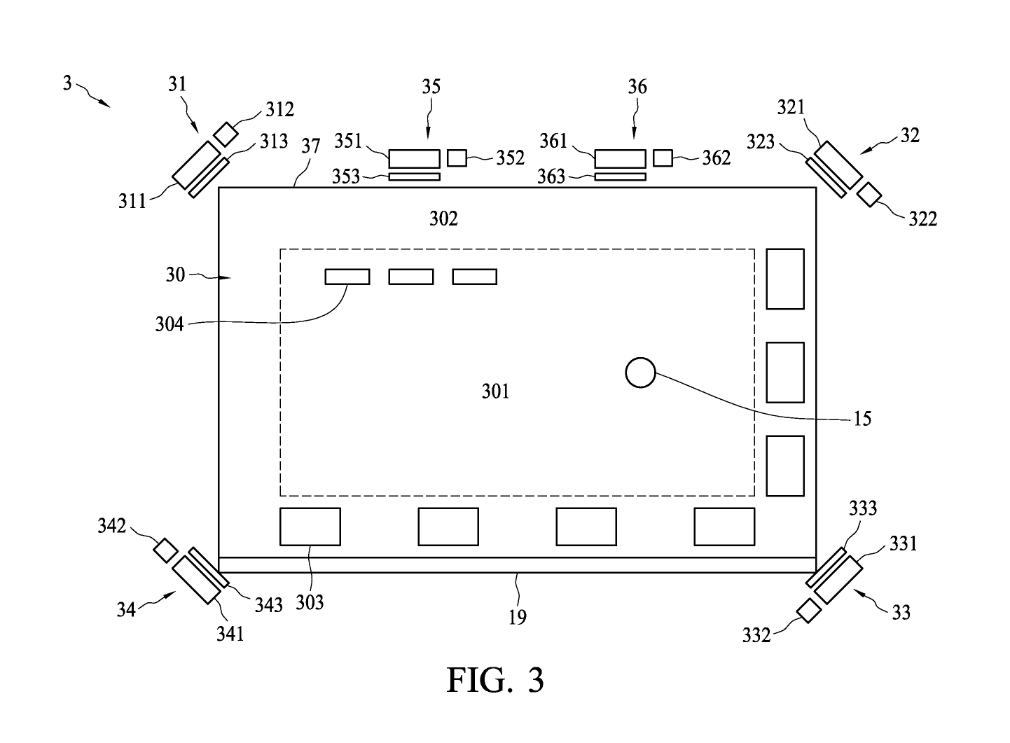

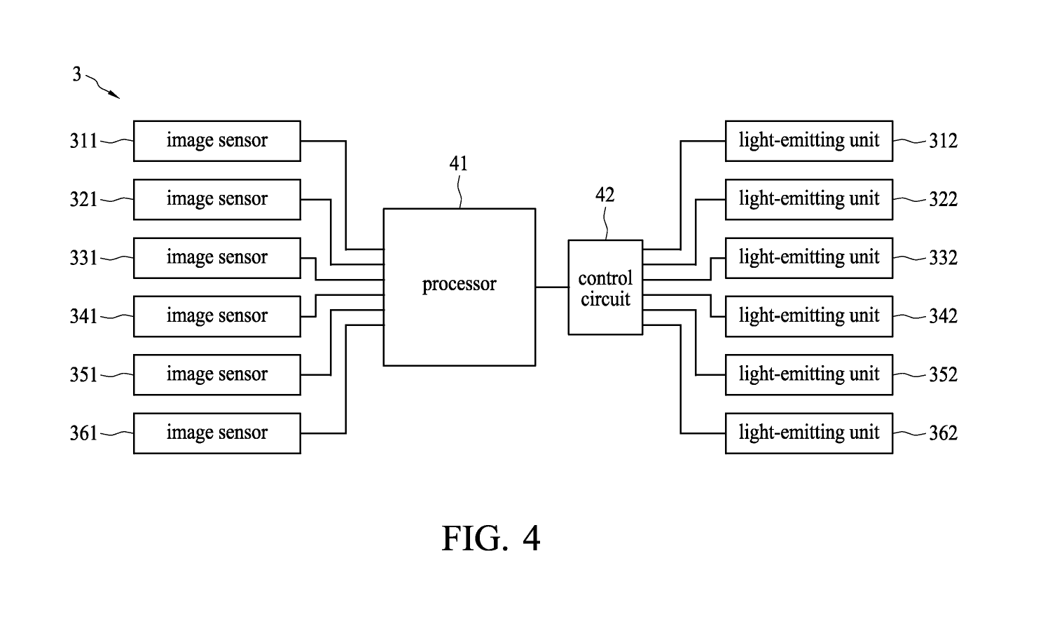

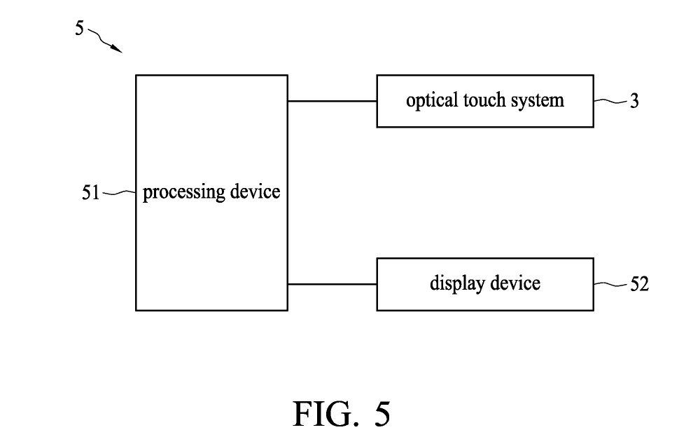

FIG. 3 schematically shows an optical touch system 3 according to another embodiment of the present invention. FIG. 4 is a diagram of the optical touch system 3. FIG. 5 schematically shows an electronic system 5 according to one embodiment of the present invention. Referring to FIG. 3, the optical touch system 3 comprises a plurality of image-sensing devices (31, 32, 33, 34, 35, and 36), which are disposed beside a touch area 30.

In one embodiment, each image-sensing device (31, 32, 35, or 36) may comprise an image sensor (311, 321, 351, or 361), a light-emitting unit (312, 322, 352, or 362), and a filter (313, 323, 353, or 363). The light-emitting units (312, 322, 352, and 362) are configured to emit first wavelength band light to illuminate an object 15 located on the touch area 30 so that the image sensor (311, 321, 351, and 361) can capture images of the object 15. The filters (313, 323, 353, and 363) are respectively disposed on light-receiving surfaces of the image sensors (311, 321, 351, and 361) so that first wavelength band light reflected from the object 15 is allowed to enter into the image sensors (311, 321, 351, and 361). The image sensors (311, 321, 351, and 361) can be used to track the object 15 on the touch area 30.

Furthermore, each image-sensing device (33 or 34) may comprise an image sensor (331 or 341), a light-emitting unit (332 or 342), and a filter (333 or 343). The light-emitting units (332 and 342) are configured to emit second wavelength band light to illuminate the object 15 on the touch area 30 so that the image sensors (331 and 341) can capture images of the object. The filters (333 and 343) are respectively disposed on light-receiving surfaces of the image sensors (331 and 341). The image sensors (331 and 341) can be used to track the object 15 on the touch area 30.

In one embodiment, the filters (313, 323, 353, and 363) can prevent the second wavelength band light from entering into the image sensors (311, 321, 351, and 361). The filters (333 and 343) can prevent first wavelength band light from entering into the image-sensing devices (33 and 34).

In one embodiment, the filters (313, 323, 353, and 363) can block light of a wavelength band other than the first wavelength band. The filters (333 and 343) can block light of a wavelength band other than the second wavelength band.

In one embodiment, the image-sensing devices (31, 32, 35, and 36) can be disposed on the same side of the touch area 30, while the image-sensing devices (33 and 34) are disposed on a different side.

In one embodiment, the touch area has two opposite sides, wherein the image-sensing devices (31, 32, 35, and 36) are disposed on one side, while the image-sensing devices (33 and 34) are disposed on another side.

In one embodiment, the touch area 30 comprises four corners and a side 37, wherein the image-sensing devices (31, 32, 33, and 34) are respectively disposed on the four corners, and the image-sensing devices (35 and 36) are disposed on the side 37.

Referring to FIG. 4, the optical touch system 3 comprises a processor 41, which may be coupled with the image sensors (311, 321, 331, 341, 351, and 361) to control the image sensors (311, 321, 331, 341, 351, and 361) for capturing images. In one embodiment, the processor 41 can control the image sensors (311, 321, 331, 341, 351, and 361) to synchronously capture to images.

Referring to FIGS. 3 to 5, the optical touch system 3 can be applied in an electronic system 5, which may further comprise a processing device 51 and a display device 52. The processing device 51 may be coupled with the optical touch system 3 and the display device 52 to control the optical touch system 3 and the display device 52.

The display device 52 may comprise a screen, and the touch area 30 can be on the screen. In one embodiment, the touch area 30 may comprise a first region 301 and a second region 302. The difference between a calculated position of the object 15 in the first region 301 and its actual position in the first region 301 is less than that between a calculated position of the object 15 in the second region 302 and its actual position in the second region 302. In order to avoid selecting a wrong choice, GUI (Graphical User Interface) elements 303 displayed on the second region 302 are configured to be larger than GUI elements 304 displayed on the first region 301. Under such arrangement, the processor 41 can concurrently control the image sensors (311, 321, 331, 341, 351, and 361) to capture images without having any unwanted results.

In one embodiment, the light-emitting units (312, 322, 352, and 362) can emit first wavelength band light having a central wavelength of 850 nanometers, and the light-emitting units (332 and 342) can emit second wavelength band light having a central wavelength of 940 nanometers.

In one embodiment, the light-emitting units (312, 322, 352, and 362) can emit first wavelength band light having a central wavelength of 940 nanometers, and the light-emitting units (332 and 342) can emit second wavelength band light having a central wavelength of 850 nanometers.

In one embodiment, the light-emitting units (312, 322, 332, 342, 352, and 362) may comprise a light-emitting diode. In one embodiment, the light-emitting unit (312, 322, 332, 342, 352, or 362) may comprise a broadband light source and an optical filter.

As shown in FIG. 4, the optical touch system 3 may comprise a control circuit 42, which may be coupled with the light-emitting units (312, 322, 332, 342, 352, and 362) to turn the light-emitting units (312, 322, 332, 342, 352, and 362) on or off.

Referring to FIG. 3, in one embodiment, the optical touch system 3 may comprise at least one retro-reflector 19, which may be disposed beside the touch area 30.

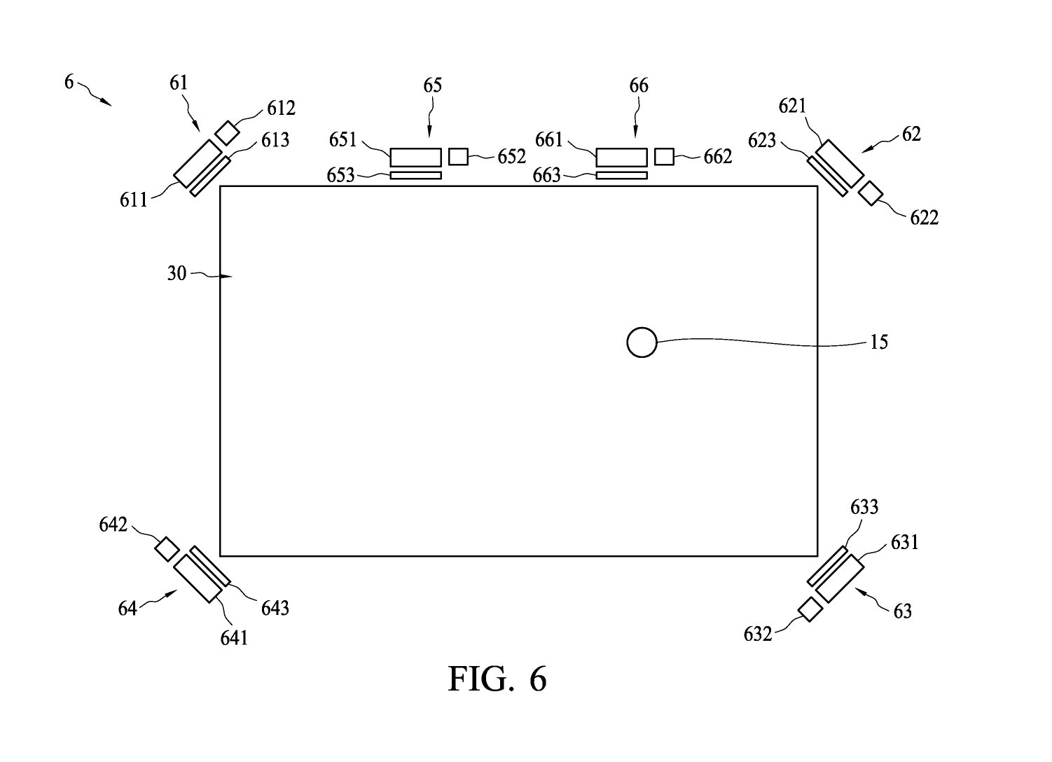

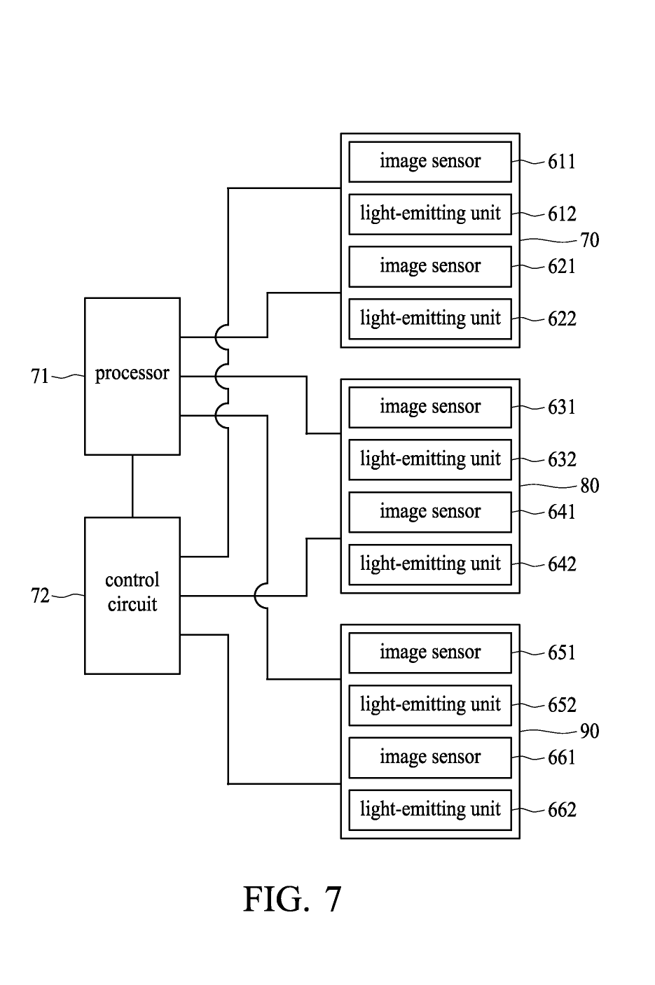

FIG. 6 schematically shows an optical touch system 6 according to another embodiment of the present invention. FIG. 7 is a diagram of the optical touch system 6. Referring to FIGS. 6 and 7, the optical touch system 6 comprises a first group of image-sensing devices 70, a second group of image-sensing devices 80, and a third group of image-sensing devices 90, all disposed beside a touch area 30.

The first group of image-sensing devices 70 is configured to track an object 15 on the touch area 30. The first group of image-sensing devices 70 may comprise a first image-sensing device 61 and a second image-sensing device 62. The first image-sensing device 61 may comprise an image sensor 611 and a light-emitting unit 612. The image sensor 611 may comprise a filter 613. The light-emitting unit 612 can emit first wavelength band light to illuminate the object 15. The filter 613 is disposed on the image sensor 611 and configured to allow first wavelength band light reflected from the object 15 to enter into the image sensor 611 and to prevent second wavelength band light from entering into the image sensor 611. The image sensor 611 can capture images of the object 15.

Moreover, the second image-sensing device 62 may comprise an image sensor 621 and a light-emitting unit 622. The image sensor 621 may comprise a filter 623. The light-emitting unit 622 can emit second wavelength band light to illuminate the object 15. The filter 623 is disposed on the image sensor 621 and configured to allow second wavelength band light reflected from the object 15 to enter into the image sensor 621 and to prevent first wavelength band light from entering into the image sensor 621. The image sensor 621 can capture images of the object 15.

The second group of image-sensing devices 80 is configured to track the object 15 on the touch area 30. The second group of image-sensing devices 80 may comprise a third image-sensing device 63 and a fourth image-sensing device 64. The third image-sensing device 63 may comprise an image sensor 631 and a light-emitting unit 632. The image sensor 631 may comprise a filter 633. The light-emitting unit 632 can emit second wavelength band light to illuminate the object 15. The filter 633 is disposed on the image sensor 631 and configured to allow second wavelength band light reflected from the object 15 to enter into the image sensor 631 and to prevent first wavelength band light from entering into the image sensor 631. The image sensor 631 can capture images of the object 15.

Moreover, the fourth image-sensing device 64 may comprise an image sensor 641 and a light-emitting unit 642. The image sensor 641 may comprise a filter 643. The light-emitting unit 642 can emit first wavelength band light to illuminate the object 15. The filter 643 is disposed on the image sensor 641 and configured to allow first wavelength band light reflected from the object 15 to enter into the image sensor 641 and to prevent second wavelength band light from entering into the image sensor 641. The image sensor 641 can capture images of the object 15.

The third group of image-sensing devices 90 is configured to track the object 15 on the touch area 30. The third group of image-sensing devices 90 may comprise a fifth image-sensing device 65 and a sixth image-sensing device 66. The fifth image-sensing device 65 may comprise an image sensor 651 and a light-emitting unit 652. The image sensor 651 may comprise a filter 653. The light-emitting unit 652 can emit first wavelength band light to illuminate the object 15. The filter 653 is disposed on the image sensor 651 and configured to allow first wavelength band light reflected from the object 15 to enter into the image sensor 651 and to prevent second wavelength band light from entering into the image sensor 651. The image sensor 651 can capture images of the object 15.

Moreover, the sixth image-sensing device 66 may comprise an image sensor 661 and a light-emitting unit 662. The image sensor 661 may comprise a filter 663. The light-emitting unit 662 can emit second wavelength band light to illuminate the object 15. The filter 663 is disposed on the image sensor 661 and configured to allow second wavelength band light reflected from the object 15 to enter into the image sensor 661 and to prevent first wavelength band light from entering into the image sensor 661. The image sensor 661 can capture images of the object 15.

In another embodiment, in the third group of image-sensing devices 90, the light-emitting unit 652 and the light-emitting unit 662 can emit light of a common wavelength band, for example, first wavelength band light or second wavelength band light. The filters (653 and 663) of the image sensors (651 and 661) allow the common wavelength band light to enter into the image sensors (651 and 661), while blocking light of wavelength bands other than the common wavelength band.

In one embodiment, the image sensors (651 and 661) of the third group of image-sensing devices 90 may have a field-of-view smaller than that of the image sensors (611 and 621) of the first group of image-sensing devices 70 and/or the image sensors (631 and 641) of the second group of image-sensing devices 80.

Referring to FIG. 7, the optical touch system 6 may comprise a processor 71. The processor 71 may be coupled with the first group of image-sensing devices 70, the second group of image-sensing devices 80, and the third group of image-sensing devices 90, and configured to sequentially control the first group of image-sensing devices 70, the second group of image-sensing devices 80, and the third group of image-sensing devices 90. The optical touch system 6 may comprise a control circuit 72, which may be configured to control the light-emitting units (612, 622, 632, 642, 652, and 662). The control circuit 72 may be coupled with the processor 71.

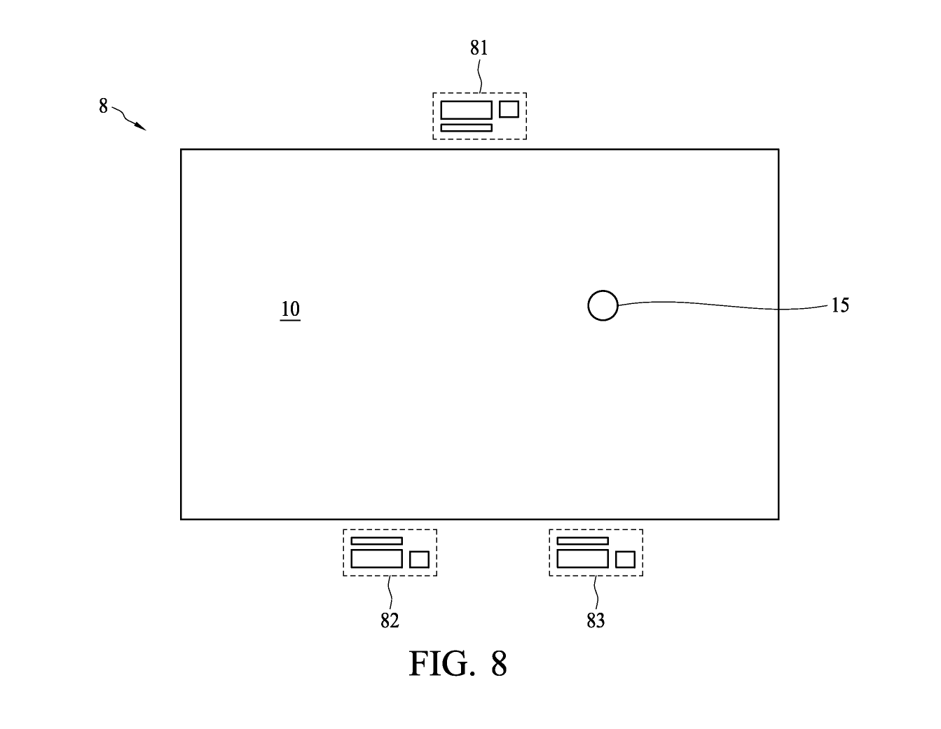

FIG. 8 schematically shows an optical touch system 8 according to another embodiment of the present invention. Referring to FIG. 8, the optical touch system 8 may comprise a first image-sensing device 81, a second image-sensing device 82, and a third image-sensing device 83, wherein the second image-sensing device 82 and the third image-sensing device 83 are disposed on the same side of an area 10, and the first image-sensing device 81 is disposed on a different side of the area 10. The first image-sensing device 81, the second image-sensing device 82, and the third image-sensing device 83 each comprises a light-emitting unit, an image sensor, and a filter that is configured to allow light of a wavelength band generated by the light-emitting unit to pass through.

In one embodiment, the second image-sensing device 82 and the third image-sensing device 83 are arranged to simultaneously capture images. When one of either the second or third image-sensing devices 82 or 83 uses light of the same wavelength band to capture images, the one of either the second or third image-sensing devices 82 or 83 and the first image-sensing device 81 are arranged to asynchronously capture images.

In one embodiment, the second image-sensing device 82 and the third image-sensing device 83 are arranged to simultaneously capture images. When the first image-sensing device 81 and either the second image-sensing device 82 or the third image-sensing device 83 uses light of different wavelength bands, the first, second, and/or third image sensing devices (81, 82, and/or 83) are arranged to simultaneously capture images.

The afore-mentioned optical touch systems are not limited to using two wavelength bands of light.

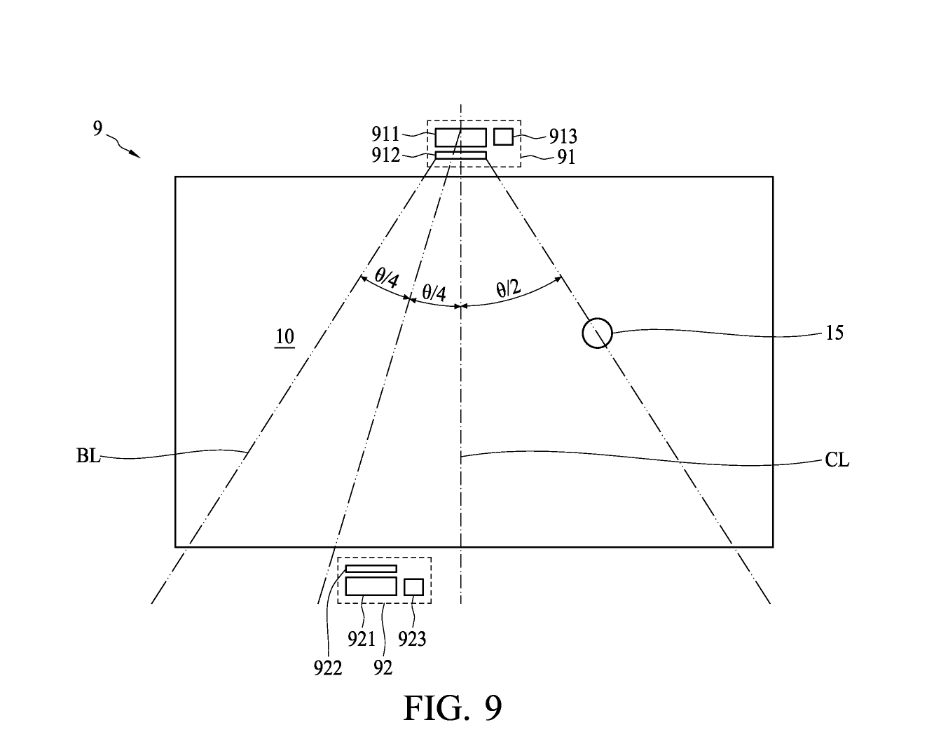

FIG. 9 schematically shows an optical touch system 9 according to another embodiment of the present invention. Referring to FIG. 9, the optical touch system 9 comprises two image-sensing devices (91 and 92). The image-sensing device 91 comprises an image sensor 911 and a light-emitting unit 913. The image sensor 911 may comprise a filter 912. The image-sensing device 92 comprises an image sensor 921 and a light-emitting unit 923. The image sensor 921 may comprise a filter 922. The image-sensing device 91 or the image sensor 911 may have a field-of-view (FOV) θ, and the image-sensing device 92 can be disposed near the center of the FOV θ. In one embodiment, the image-sensing device 92 is located in one-half of an angle range from a field-of-view centerline CL to a field-of-view boundary BL.

In one embodiment, the light-emitting units (913 and 923) emit different wavelength band light.

In one embodiment of the present invention, an optical touch system comprises a plurality of image-sensing devices. The plurality of image-sensing devices synchronously captures images; therefore, the optical touch system will not produce incorrect calculations caused by capturing object images in different periods.

In one embodiment of the present invention, an optical touch system comprises a plurality of image-sensing devices, in which a portion of the image-sensing devices are configured to simultaneously capture images. Because there are a portion of image-sensing devices configured to simultaneously capture images, the duration between the time when the first image is captured and the time when the last image is captured can be shortened. As a result, the incorrect calculation caused by a significant difference between the first image and the last image can be avoided.

In one embodiment of the present invention, an optical touch system comprises two image-sensing devices that use light of different wavelength bands to capture object images. Due to using light of different wavelength bands, the two image-sensing devices can simultaneously capture images without causing interference.

In one embodiment of the present invention, an optical touch system comprises a plurality of image-sensing devices, in which two image-sensing devices located on different sides of a touch area, and using light of the same wavelength, can be configured to asynchronously capture images. In one embodiment, the two image-sensing devices asynchronously capturing images are configured to capture images during two non-overlapping periods. In one embodiment, two asynchronously captured images can be respectively generated during two partially overlapping periods.

In one embodiment of the present invention, an optical touch system comprises a plurality of groups of image-sensing devices, and each group comprises a plurality of image-sensing devices, wherein the groups of image-sensing devices are configured to sequentially capture images. In one embodiment, each group uses light of different wavelength bands to capture images. In one embodiment, each group uses light of the same wavelength band to capture images. In one embodiment, different groups of image-sensing devices use light of different wavelength bands to capture images.

In one embodiment of the present invention, an optical touch system comprises a plurality of image sensors, a plurality of filters, and a plurality of light-emitting units. The plurality of light-emitting units emits light of different wavelength bands. The plurality of filters allows the light of different wavelength bands to pass through and is correspondingly disposed on the plurality of image sensors. In one embodiment, the plurality of light-emitting units corresponds to the plurality of image sensors. In another embodiment, the plurality of light-emitting units does not correspond to the plurality of image sensors.

It will be apparent to those skilled in the art that various modifications can be made to the disclosed embodiments. It is intended that the specification and examples be considered as exemplary only, with the true scope of the disclosure being indicated by the following claims and their equivalents.

What is claimed is:

1. An optical touch system comprising:
at least one first light-emitting unit configured to generate first wavelength band light;
at least one second light-emitting unit configured to generate second wavelength band light;
at least one first image sensor comprising a first filter, wherein the at least one first light-emitting unit is configured to generate the first wavelength band light when the at least one first image sensor is capturing images, and the first filter is configured to allow the first wavelength band light to enter into the at least one first image sensor and to prevent the second wavelength band light from entering into the at least one first image sensor; and
at least one second image sensor comprising a second filter, wherein the at least one second light-emitting unit is configured to generate the second wavelength band light when the at least one second image sensor is capturing images, and the second filter is configured to allow the second wavelength band light to enter into the at least one second image sensor and to prevent the first wavelength band light from entering into the at least one second image sensor.

2. The optical touch system of claim 1, wherein the at least one first image sensor and the at least one second light-emitting unit are arranged to face toward each other, and the at least one second image sensor and the at least one first light-emitting unit are arranged to face toward each other.

3. The optical touch system of claim 1, wherein the at least one first image sensor and the at least one second image sensor are respectively disposed on two opposite sides of a touch area, and the at least one first light-emitting unit and the at least one second light-emitting unit are respectively disposed on the two opposite sides of the touch area.

4. The optical touch system of claim 1, comprising four first image sensors and two second image sensors.

5. The optical touch system of claim 4, comprising a processor, wherein the processor is configured to control the four first image sensors and the two second image sensors to synchronously capture images.

6. The optical touch system of claim 4, further comprising four first light-emitting units corresponding to the four first image sensors and two second light-emitting units corresponding to the two second image sensors.

7. The optical touch system of claim 1, further comprising a processor, wherein a touch area comprises two opposite sides; the at least one first image sensor comprises two first image sensors respectively disposed on the two opposite sides; the at least one second image sensor comprises two second image sensors respectively disposed on the two opposite sides; wherein the processor is configured to control the two first image sensors to asynchronously capture images, to control the two second image sensors to asynchronously capture images, and to control one first image sensor and one second image sensor on the same side of the two opposite sides to synchronously capture images.

8. The optical touch system of claim 1, further comprising at least one retro-reflector configured to reflect the first or second wavelength band light.

9. An optical touch system comprising:
at least one first image-sensing device comprising a light-emitting unit and an image sensor, the image sensor of the at least one first image-sensing device comprising a first filter, the light-emitting unit of the at least one first image-sensing device being configured to generate first wavelength band light when the image sensor of the at least one first image-sensing device is capturing images; and
at least one second image-sensing device comprising a light-emitting unit and an image sensor, the image sensor of the at least one second image-sensing device comprising a second filter, the light-emitting unit of the at least one second image-sensing device being configured to generate second wavelength band light when the image sensor of the at least one second image-sensing device is capturing images;
wherein the first filter is configured to allow the first wavelength band light to pass through and to block the second wavelength band light, and the second filter is configured to allow the second wavelength band is light to pass through and to block the first wavelength band light.

10. The optical touch system of claim 9, wherein the at least one first image-sensing device and the at least one second image-sensing device are disposed on a same side of a touch area.

11. The optical touch system of claim 9, wherein the at least one first image-sensing device and the at least one second image-sensing device are respectively disposed on different sides of a touch area.

12. The optical touch system of claim 9, wherein the at least one first image-sensing device and the at least one second image-sensing device are respectively disposed on two adjacent corners of a touch area.

13. The optical touch system of claim 9, further comprising a processor, a plurality of first image-sensing devices, and a plurality of second image-sensing devices, wherein the plurality of first image-sensing devices are disposed on a side of a touch area, the plurality of second image-sensing devices are disposed on another side of the touch area, and the processor is configured to control the plurality of first image-sensing devices and the plurality of second image-sensing devices to synchronously capture images.

14. The optical touch system of claim 9, further comprising a processor and two first image-sensing devices respectively disposed on different sides of a touch area, wherein the processor is configured to control the two first image-sensing devices to asynchronously capture images.

15. The optical touch system of claim 9, further comprising three first image-sensing devices and three second image-sensing devices, wherein the three first image-sensing devices are respectively disposed on two corners and a side of a touch area, and the three second image-sensing devices are respectively disposed on another two corners and the side of the touch area.

16. The optical touch system of claim 9, further comprising at least one retro-reflector configured to reflect the first or second wavelength band light.

17. An optical touch system comprising:
a first group of image-sensing devices disposed on a side of a touch area, the first group of image-sensing devices comprising:
a first image-sensing device comprising a light-emitting unit and an image sensor comprising a filter, wherein the light-emitting unit of the first image-sensing device is configured to generate first wavelength band light when the image sensor of the first image-sensing device is capturing images; and
a second image-sensing device comprising a light-emitting unit and an image sensor comprising a filter, wherein the light-emitting unit of the second image-sensing device is configured to generate second wavelength band light when the image of the second image-sensing device is capturing images, wherein the filter of the first image-sensing device is configured to allow the first wavelength band light to pass through and to block the second wavelength band light, and the filter of the second image-sensing device is configured to allow the second wavelength band light to pass through and to block the first wavelength band light;
a second group of image-sensing devices disposed on another side of the touch area opposite to the side, the second group of image-sensing devices comprising:
a third image-sensing device comprising a light-emitting unit and an image sensor comprising a filter, wherein the light-emitting unit of the third image-sensing device is configured to generate the first wavelength band light when the image sensor of the third image-sensing device is capturing images; and
a fourth image-sensing device comprising a light-emitting unit and an image sensor comprising a filter, wherein the light-emitting unit of the fourth image-sensing device is configured to generate the second wavelength band light when the image sensor of the fourth image-sensing device is capturing images, wherein the filter of the third image-sensing device is configured to allow the first wavelength band light to pass through and to block the second wavelength band light, and the filter of the fourth image-sensing device is configured to allow the second wavelength band light to pass through and to block the first wavelength band light; and
a processor configured to sequentially control the first and second group of image-sensing devices to capture images.

18. The optical touch system of claim 17, further comprising a third group of image-sensing devices disposed on the side of the touch area, the third group of image-sensing devices comprising:
a fifth image-sensing device comprising a light-emitting unit and an image sensor comprising a filter, wherein the light-emitting unit of the fifth image-sensing device is configured to generate light of a wavelength band when the image sensor of the fifth image-sensing device is capturing images; and
a sixth image-sensing device comprising a light-emitting unit and an image sensor comprising a filter, wherein the light-emitting unit of the sixth image-sensing device is configured to generate light of the wavelength band when the image sensor of the sixth image-sensing device is capturing images, wherein the filter of the fifth image-sensing device is configured to allow the light of the wavelength band to pass through and block light of another wavelength band, and the filter of the sixth image-sensing device is configured to allow the light of the wavelength band to pass through and to block the light of the another wavelength band;
wherein when the light of the wavelength band is the first wavelength band light, the light of the another wavelength band is the second wavelength band light, or when the light of the wavelength band is the second wavelength band light, the light of the another wavelength band is the first wavelength band light.

19. The optical touch system of claim 18, wherein the third group of image-sensing devices has a field-of-view smaller than that of the first and second group of image-sensing devices.

20. The optical touch system of claim 17, further comprising at least one retro-reflector configured to reflect the first or second wavelength band light.

21. An optical touch system comprising:
first and second image-sensing devices each comprising:
an image sensor comprising a filter; and
a light-emitting unit configured to generate light when the image sensor is capturing images;
wherein the first image-sensing device is disposed near a center of a field-of-view of the second image-sensing device.

22. The optical touch system of claim 21, wherein the first image-sensing device is in one-half of an angle range from a field-of-view to centerline to a field-of-view boundary.

23. The optical touch system of claim 21, wherein the light-emitting units of the first and second image-sensing device are configured to generate light of different wavelength bands.
